(19) United States
(12) Patent Application Publication
(10) Pub. No.: US 2013/0047490 A1
(43) Pub. Date: Feb. 28, 2013

(54) Fishing lure

(71) Applicant: Adam Jay Gilmore, Clare, MI (US)

(72) Inventor: Adam Jay Gilmore, Clare, MI (US)

(21) Appl. No.: 13/199,458

(22) Filed: Aug. 31, 2011

(51) Int. Cl. A01K 85/00

(52) U.S. Cl. 43/42; 43/42.44

(57) ABSTRACT

A fishing lure comprising a shaft, means at one end of the shaft for affixing a line thereto, a means located at the other end for attaching a fishing hook, said shaft being tapered to a point at the end which is to be attached to the fishing line, a means for preventing a bait that is skewered onto the shaft from slipping off from the hook end of the shaft.

### BACKGROUND OF THE INVENTION

1. Field of the Invention

The present invention relates to fishing lures, and more particularly refers to a fishing lure that can be used with live or artificial bait.

2. Description of the Prior Art

Fishing lures such as plain hooks have been around forever. There are many drawbacks to the suggested designs, one of the most important being that live or artificial baits are easily lost during fish strikes without hooking the fish. The suggested designs are also difficult to manufacture and they are complicated to use.

The following list of United States Patents and publications teach various attempts to cure the problem: U.S. Pat. Nos. 70,913; 1,717,376; 2,825,174; 3,359,675; 3,435,553; 3,494,066; 3,834,060; 4,094,087; 4,251,942; 4,688,347; 4,738,048; 4,785,571; 5,386,661; 6,038,806; and 2008/0083154A1.

They all suffer from one or more problems. They are cumbersome to use, they are ineffective and they are costly. They mostly rely on the attachment of the bait by passing it over the hook barb and then up the shaft. As is demonstrated by the aforementioned patents the solution to the problem of stolen bait from a fishing lure is still a problem to be solved. The present invention uniquely solves the problem through an effective, simple but still unique designed fishing lure.

### SUMMARY OF THE INVENTION

According to the invention a fishing lure is provided comprising an independent shaft that defines apertures at both ends, one end of which is tapered to a sharp point, means provided through the aperture defined at the sharpened end of the shaft for affixing a line thereto, a means connected through the aperture formed in the shaft at other end for attaching a hook so it freely swings from the shaft and a means for preventing a bait skewered on the shaft from slipping onto the hook. The fishing lure comprises in one embodiment, a shaft having two ends, one of said ends tapered to a sharp point to form a sharpened end and at least two apertures defined by the shaft, one near each end of the shaft and a means located at the end opposite to the sharpened end to reduce the tendency of bait from slipping off of the shaft. The fishing lure may include a detachable swivel for securing a fishing line, attached through the aperture located at the sharp end of the shaft. The fishing lure may also include a hook attached to the end of the shaft opposite to the sharpened end by a means positioned in the aperture in that end in a manner to permit the hook to freely swing from the shaft.

In another embodiment a fishing lure is described comprising: a shaft comprising a first end, a second end, and a stopper, wherein said shaft defines apertures there through near each of said ends and wherein at least one end defines a sharp point (sharpened end), a means mounted through said aperture at the sharp end for detachably connecting said shaft to a fishing line; a fishing hook comprising at least one eye, and a means for attaching said hook to said shaft through the aperture at the end opposite to the sharpened end so that the hook freely swings from said shaft. In another embodiment the lure comprises at least two of the defined shafts attached to each other so they flex and may contain two hooks, one attached to each shaft so as to freely swing there from.

### BRIEF DESCRIPTION OF THE DRAWINGS

In the drawings:

FIG. 1 is a view of one embodiment of a fishing lure according to the invention showing a shaft, a means for attaching a fishing line, a means for attaching a hook, a hook, and a means for preventing bait from slipping off of the shaft.

FIG. 2 is an exploded view of the fishing lure shown in FIG. 1.

FIG. 3 is a view of a fishing lure according to the invention showing how a live minnow 22 is attached.

FIG. 4 is a view of another embodiment of the invention including two shafts and two hooks.

### DESCRIPTION OF THE PREFERRED EMBODIMENTS

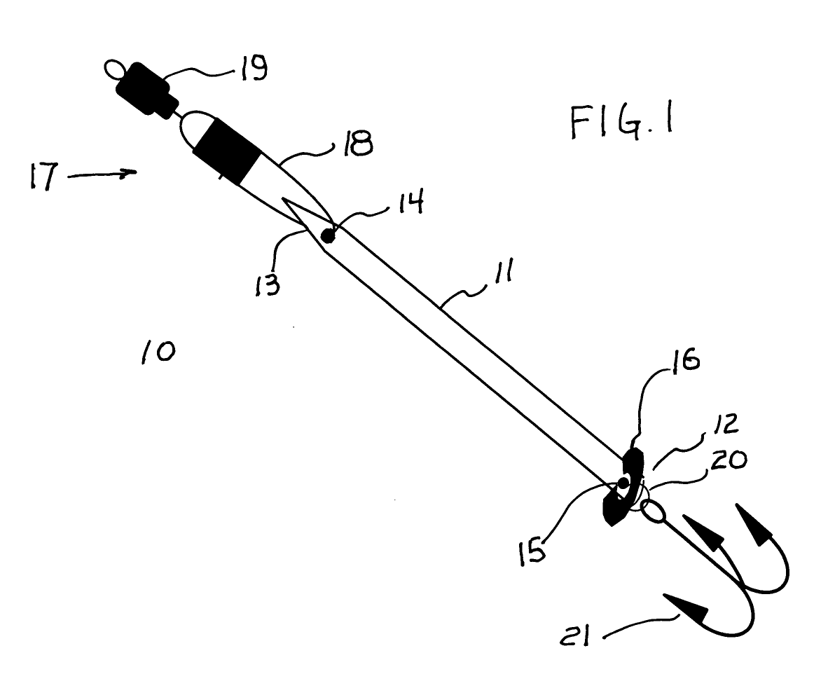

Referring to FIG. 1, a fishing lure 10 according to the invention is shown comprising a body portion (e.g. a shaft) 11 having two ends, 12 and 13 (13 defining a sharp point), said shaft defining apertures 14 and 15 at each end. The shaft also includes a removable or fixed means 16 (stopper) located near to the end 12 for preventing bait from slipping off of the shaft. The basic invention is defined by the foregoing. In this embodiment is also shown a means 17 located at the sharp end for securing a fish line (in this embodiment the means 17 comprising a removable clip 18 and a swivel 19). Also included is a means 20 (in this embodiment a split ring) through the aperture 14 for attaching fishing hook 21 to the lure so that the fish hook freely swings from said shaft.

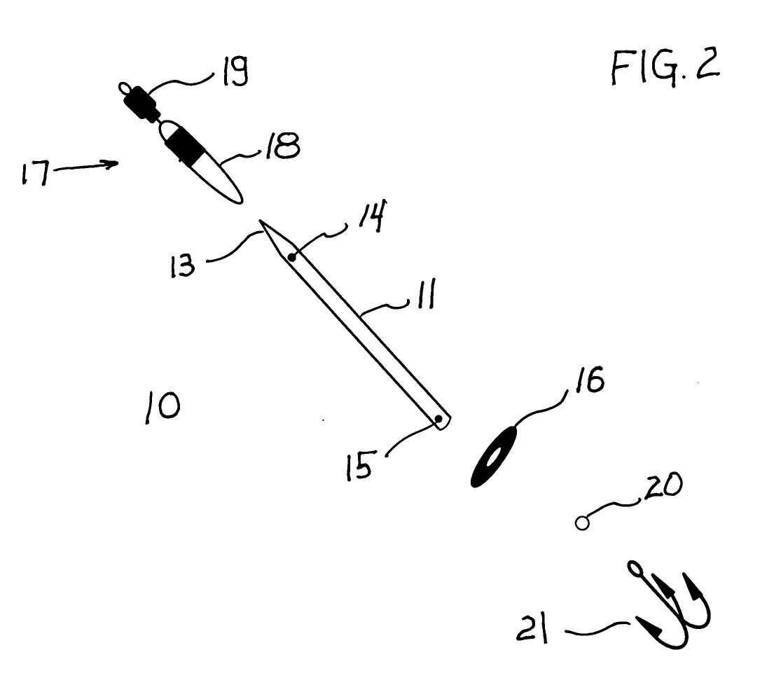

FIG. 2 is an exploded view of the embodiment show in FIG. 1.

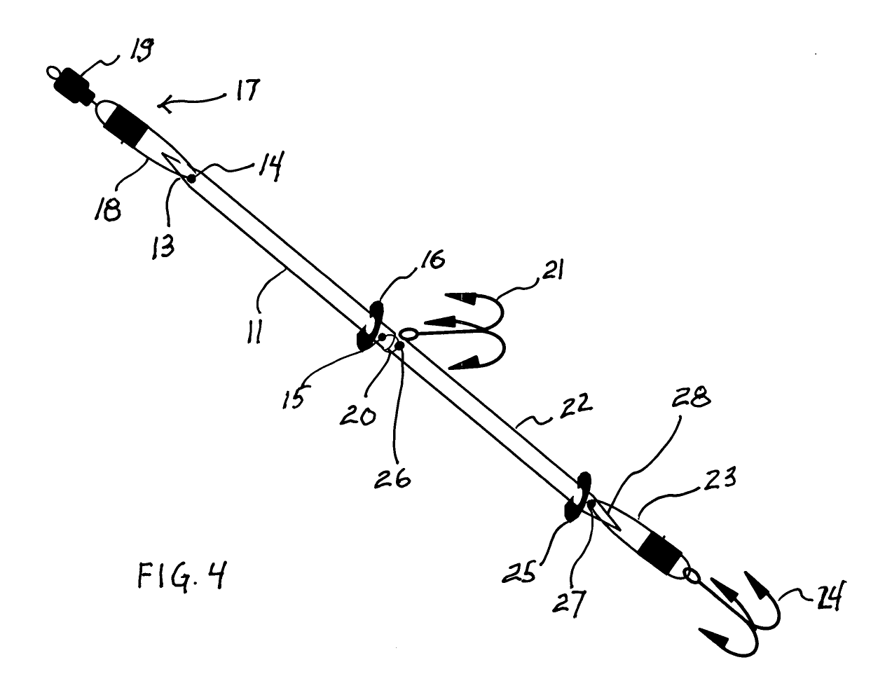

The shaft can be made from any suitable material that is used for fishing lures. It can be manufactured from metal or plastic materials. Bronze, brass, steel, stainless steel, plastic etc can be used. The length can be varied to fit the intended use, running from smaller sizes for catching pan fish up to large sizes that can be used for lake trout and deep sea fishing. The shaft can be round, square, or any other shape as long as the end opposite the hook is tapered to a sharp point to pierce (skewer) the live or artificial bait. In FIG. 1 the sharp end is located at the end to be attached to the fishing line. As shown in FIG. 4 the sharp end of the shaft is located at the hook end. Both ends may be sharpened but from a practical point only one end need be sharp. The length of the shaft may be adjustable. Multiple shafts may be joined together using split rings or other attaching means to permit the shafts to flex one to the other. This embodiment is shown in FIG. 4. An additional hook may be added at the point of attachment of one shaft to other in a manner to permit the hook to freely swing from the shafts. FIG, 4 illustrates the use of a second shaft 22, a means for attaching a second hook, in this example a releasable clip 23, and a second treble hook 24. A second stopper, 25, is also positioned on the second shaft 22. The second shaft is also provided with two apertures 26 and 27 and a sharpened end 28.

The aperture at the end located opposite to the hook may be used for attaching a fishing line. The line may be threaded through the aperture and tied. Preferably, however, a releasable swivel is used to prevent twisting of the fishing line when trolling, casting or the like. The means for releasing the swivel from the aperture can be commonly known clips that are permanently attached to one end of the swivel or releasable from the swivel as well as from the shaft. The swivel and clip can be made of a material normally used to manufacture such fishing accessories.

The means for attaching a fishing hook is preferably a device that permits the hook to freely swing about the end of the shaft. Split rings, swivels, releasable clips and the like can be used. It is preferable that the attaching means is releasable from at least the hook so that different types of hooks can be used.

The fishing hook may comprise any hook known in the art and is usually selected depending on the type of fish being caught. They can be made of chromed steel, bronze or the like. They can be single, double or treble hooks and also may include cattails and other types of fishing lures.

The means 16 (herein called “stopper”) for preventing a bait from slipping off of the shaft as shown in the embodiment is a washer that is sized to slip over the shaft and is prevented from sliding off onto the hook by the split ring or other means used to fasten the fish hook to the shaft. Other means could include barb(s) facing away from the hook, a knob formed as part of the shaft or any other suitable means.

Spinners, spoons and other similar fishing lure adaptations can be included as part of the lure of the present invention.

It is to be understood that the invention is not to be limited to the exact details of construction or operation or materials shown and described, as obvious modifications and equivalents will be apparent to one skilled in the art.

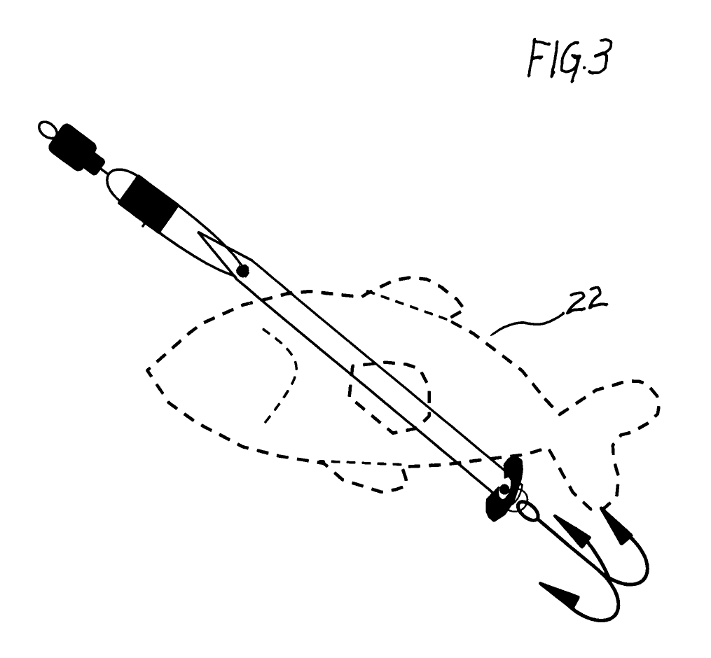

In use the means for attaching the lure to the fishing line is first released from the shaft. The bait, for example, night crawler, leaf worm, minnow, crayfish, shrimp, artificial bait such a plastic worm, frog is skewered onto the shaft using the sharpen end of the shaft. A minnow is attached as shown in FIG. 3, The line is then attached and the lure used in any usual fishing method, e.g. still fishing, trolling, casting and the like.

### EXAMPLE

An embodiment of the invention was made as follows. A stainless steel shaft approximately 2.5 inches long and ⅛ inch in diameter was ground at one end to a form a sharp point. Two holes were drilled close to each end of the shaft using a 1/16 inch steel drill. The hole in the end of the shaft opposite to the sharp end was drilled about one eight inch from the end. The other hole was drilled about a quarter inch from the point. A No. 3 split ring was used to attach a No. 2 treble hook to the blunt end of the shaft. It swung freely from the shaft. A clip-barrel swivel was attached through the aperture at the sharp end. A 3/16 inside diameter washer having an outside diameter of about seven/sixteenth inch was slid over the shaft to act as a stopper when it engaged the split ring. The lure was used with shrimp bait to successfully catch, by casting, catfish, and the like. The bait is attached by detaching the swivel from the sharp end and skewering the shrimp onto the shaft by piercing it with the sharp end of the shaft. The shrimp was prevented from sliding off of the shaft by the washer that acted as a stopper.

What is claimed is:

1. A fishing lure comprising:
a shaft having two ends, one of said ends tapered to a sharp point to form a sharpened end and at least two apertures defined by the body member one located near the sharpened end of the shaft and one located at the other end and a means located at the end opposite to the sharpened end to reduce the tendency of bait from slipping off of the shaft.

2. A fishing lure according to claim 1, including a detachable swivel attached through the aperture located at the sharp end of the shaft for securing a fishing line.

3. A fishing lure according to claim 1, including a hook attached to the end of the shaft opposite to the sharpened end by a means positioned in the aperture in that end in a manner to permit the hook to freely swing from the shaft.

4. A fishing lure according to claim 3, including in addition a second shaft attached to said first shaft and a hook attached at the point of attachment of the two shafts by a means permitting the hook to freely swing from the shafts and a second hook attached at the end opposite of the attachment of the two shafts by a means permitting the second hook to freely swing from the shafts.

5. A fishing lure comprising:
a. a shaft comprising a first sharpened end, a second end, and a stopper, wherein said shaft defines apertures there through near each of said ends ,
b. a means for detachably connecting said shaft through said aperture in said sharpened end to a fishing line;
c. a fishing hook comprising at least one eye, and
d. a means for attaching said hook to said shaft through the aperture at the end opposite to the sharpened end so that the hook freely swings from said shaft.

6. The fishing lure of claim 5, wherein said means for attaching said hook is a split ring.

7. The fishing apparatus of claim 5, wherein said shaft is hollow.

8. The fishing apparatus of claim 5, wherein the length of said shaft is adjustable.

9. The fishing apparatus of claim 5, wherein said means for attaching a fishing line is a clip-swivel combination.

10. A fishing lure according to claim 5, wherein said shaft is formed of stainless steel.

11. A fishing lure according to claim 5 including a spinner.

12. A fishing lure according to claim 5, including a second shaft attached to the first shaft at the end opposite to the sharpened end said connecting means permitting the shafts to flex one to the other and said means including a means for securing a second hook to said shaft at the point of attachment of the two shafts, said hook attached so as to freely swing form said shafts.
